(19) United States
(12) Patent Application Publication
(10) Pub. No.: US 2026/0079690 A1
(43) Pub. Date: Mar. 19, 2026

(54) IDENTIFYING MINIMAL DEPENDENCY UPDATES TO MITIGATE KNOWN CVES FOR SOFTWARE PROJECTS WITHOUT SEMANTIC VERSIONING

(71) Applicant: Red Hat, Inc., Raleigh, NC (US)

(72) Inventors: Leigh Griffin, Waterford (IE); Paolo Antinori, Milan (IT); Andrea Cosentino, Milan (IT)

(21) Appl. No.: 18/890,363

(22) Filed: Sep. 19, 2024

(51) Int. Cl. G06F 8/65

(52) U.S. Cl. CPC G06F 8/65

(57) ABSTRACT

Based on a specification file descriptive of a particular version of each of a plurality of dependent software packages utilized by a software project, Common Vulnerability and Exposure (CVE) information that identifies a first dependent software package of the plurality of dependent software packages as being associated with a known CVE can be accessed. An updated version of the first dependent software package that mitigates the known CVE can be identified. A determination that the updated version of the first dependent software package is compatible with the software project can be made. Responsive to the determination, a specification update for the specification file can be generated, wherein the specification update modifies the specification file such that the software project utilizes the updated version of the first dependent software package.

### BACKGROUND

Specification files (or "build" files) are critical components in software projects that define how the project should be compiled, packaged, and managed. Specification files contain instructions for building the software, including which dependencies need to be included, how the source code should be compiled, and what configurations should be applied during the build process. Common examples of build files include Makefile in C/C++ projects, pom.xml in Java projects using Apache Maven®, package.json in Node.js® projects, and build.gradle in projects using Gradle®. A “dependency” included in a specification file can refer to a package of software instructions upon which the software project depends (e.g., an Application Programming Interface (API), a package from a package manager such as Node, a software module, a software library, a software framework such as Django or React, a software plugin, etc.).

Large-scale software projects often depend on a substantial quantity of dependent software packages that provide a variety of different functions. It is relatively common for some (or many) of these dependent software packages to be created, managed, updated, etc. by entities who are unrelated to the software project. For example, it is common for a software project by a large multinational corporations to depend on multiple open-source packages created by different teams that are otherwise unrelated to the corporation.

### SUMMARY

A specification file can be obtained that describes a current version of dependent software packages for a software project. For some of the packages that are associated with known Common Vulnerabilities and Exposures (CVEs), updated version(s) of those dependent software package(s) that mitigate the known CVEs can be identified. A determination can be made that the updated version(s) are compatible with the software project, and based on the determination, the specification file can be updated such that the software project utilizes the updated version of the software package.

In one implementation, a method is provided. The method includes, based on a specification file descriptive of a particular version of each of a plurality of dependent software packages utilized by a software project, accessing, by a computing system comprising one or more computing devices, CVE information that identifies a first dependent software package of the plurality of dependent software packages as being associated with a known CVE. The method further includes identifying, by the computing system, an updated version of the first dependent software package that mitigates the known CVE. The method further includes making, by the computing system, a determination that the updated version of the first dependent software package is compatible with the software project. The method further includes, responsive to the determination, generating, by the computing system, a specification update for the specification file, wherein the specification update modifies the specification file such that the software project utilizes the updated version of the first dependent software package.

In another implementation, a computing system is provided. The computing device includes a memory, and one or more computing devices coupled to the memory. The one or more computing devices are to, based on a specification file descriptive of a particular version of each of a plurality of dependent software packages utilized by a software project, access CVE information that identifies a first dependent software package of the plurality of dependent software packages as being associated with a known CVE. The one or more computing devices are further to identify an updated version of the first dependent software package that mitigates the known CVE. The one or more computing devices are further to make a determination that the updated version of the first dependent software package is compatible with the software project. The one or more computing devices are further to generate a specification update for the specification file, wherein the specification update modifies the specification file such that the software project utilizes the updated version of the first dependent software package.

In another implementation, a non-transitory computer-readable storage medium is provided. The non-transitory computer-readable storage medium includes executable instructions to cause one or more processor devices to, based on a specification file descriptive of a particular version of each of a plurality of dependent software packages utilized by a software project, access CVE information that identifies a first dependent software package of the plurality of dependent software packages as being associated with a known CVE. The instructions further cause the one or more processor devices to identify an updated version of the first dependent software package that mitigates the known CVE. The instructions further cause the one or more processor devices to make a determination that the updated version of the first dependent software package is compatible with the software project. The instructions further cause the one or more processor devices to, responsive to the determination, generate a specification update for the specification file, wherein the specification update modifies the specification file such that the software project utilizes the updated version of the first dependent software package.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing environment suitable for identifying minimal dependency updates to mitigate known Common Exploits and Vulnerabilities (CVEs) for software projects without semantic versioning according to some implementations of the present disclosure.

FIG. 2 is a data flow diagram for the compatibility determination module of FIG. 1 being utilized to determine compatibility of updated dependent software packages according to some implementations of the present disclosure.

FIG. 3 is a flowchart illustrating operations performed by the computing system of FIG. 1 for identifying minimal dependency updates to mitigate known CVEs for software projects without semantic versioning, according to one example.

FIG. 4 is a block diagram of the computing device of FIG. 1 for identifying minimal dependency updates to mitigate known CVEs for software projects without semantic versioning, according to one example.

FIG. 5 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Specification files (or "build" files) are critical components in software projects that define how the project should be compiled, packaged, and managed. Specification files contain instructions for building the software, including which dependencies need to be included, how the source code should be compiled, and what configurations should be applied during the build process. Common examples of build files include Makefile in C/C++ projects, pom.xml in Java projects using Apache Maven®, package.json in Node.js® projects, and build.gradle in projects using Gradle®. A “dependency” included in a specification file can refer to a package of software upon which the software project depends (e.g., an Application Programming Interface (API), a software package from a package manager such as Node, a software module, a software library, a software framework such as Django or React, a software plugin, etc.).

Large-scale software projects often depend on a substantial quantity of dependent software packages that provide a variety of different functions. It is relatively common for some (or many) of these dependent software packages to be created, managed, updated, etc. by entities who are unrelated to the software project. For example, it is common for a software project by a large multinational corporations to depend on multiple open-source packages created by different teams that are otherwise unrelated to the corporation.

However, these dependencies have the capacity to introduce substantial security vulnerabilities in the software projects that depend upon them. There are many instances in which a vulnerability in a single dependent software package has been leveraged to facilitate malicious attacks against multiple large software projects that depend upon the dependent software package. To mitigate these vulnerabilities, some entities routinely publish publicly accessibly lists of Common Vulnerabilities and Exposures (CVEs). CVEs refer to known security vulnerabilities in dependent software packages.

Once a CVE is published for a particular software package, the developers of the software package will often create a new version of the software package that mitigates the vulnerability. CVEs also serve to inform creators of software projects when a software package depended on by the software project may be vulnerable. In such instances, once an updated version of the affected software package is released, the creators of the software project can modify the specification file for the software project such that the software project is “built” (e.g., compiled, instantiated, etc.) using the updated version of the affected software package, rather than the prior version that includes vulnerabilities.

Most CVEs in dependent software packages must be quickly mitigated to maintain effective protection of a large software project. Generally, this is accomplished by updating the software package or by selecting a similar software package to fulfill the same role. However, many dependent software packages are dependent upon other dependent software packages, and as such, updating a software package (or switching the package entirely) can serve as a vector for errors and bugs. For example, assume that a CVE is found for a dependent software package that exploits the name of an invokable function of the software package. If the developers of the software package mitigate the CVE by changing the name of the invokable function, the update may inadvertently break other software packages which invoke that invokable function by name.

To reduce the likelihood that errors or bugs are introduced, creators of large software projects prefer to refrain from updating (or switching) dependent software packages unless otherwise necessary. Some dependent software package developers utilize Semantic Versioning (semver) techniques to create versioning information which can clearly indicate whether a new version of the software package mitigates a known CVE. However, many other dependent software package developers do not use any type of semantic versioning technique to indicate such information. Without this indication, it can be prohibitively difficult for creators of large software projects to determine whether an update to a dependent software package mitigates a known CVE, and if so, apply the update. As such, a technique to determine a minimal update needed to mitigate known CVEs is greatly desired.

Accordingly, implementations described herein propose identification of minimal dependency updates to mitigate known CVEs for non-semver software projects. More specifically, a computing system associated with a non-semver software project can obtain a specification file for the software project. The specification file can describe each dependent software package utilized by a software project. The specification file can also indicate a particular version of each of the dependent software projects utilized by the software project. Based on the specification file, the computing system can access Common Vulnerability and Exposure (CVE) information that identifies one or more of the dependent software packages utilized by the software project as being associated with one or more known CVEs.

For each of the dependent software packages that are associated with CVE(s), the computing system can identify an updated version of the dependent software package that mitigates the known CVE(s). The computing system can make a determination that the updated version of the dependent software package is compatible with the software project. Responsive to the determination, the computing system can generate a specification update for the specification file. The specification update can modify the software project to utilize the updated version of the dependent software package. In such fashion, implementations described herein can dynamically mitigate known CVEs by updating affected software packages while minimizing non-necessary updates.

Aspects of the present disclosure provide a number of technical effects and benefits. As one example technical effect and benefit, implementations described herein improves the functionality of cybersecurity systems by mitigating known CVEs. More specifically, known CVEs associated with dependent software packages must be mitigated quickly to avoid exposure to malicious actors. Software packages generally must be updated to mitigate known CVEs, and updating software packages can break cross-dependencies with other packages. By identifying and evaluating the severity of a known CVE for a dependent software package, implementations described herein can mitigate known CVEs to protect software projects without introducing bugs and errors associated with unnecessary updates to dependent software packages.

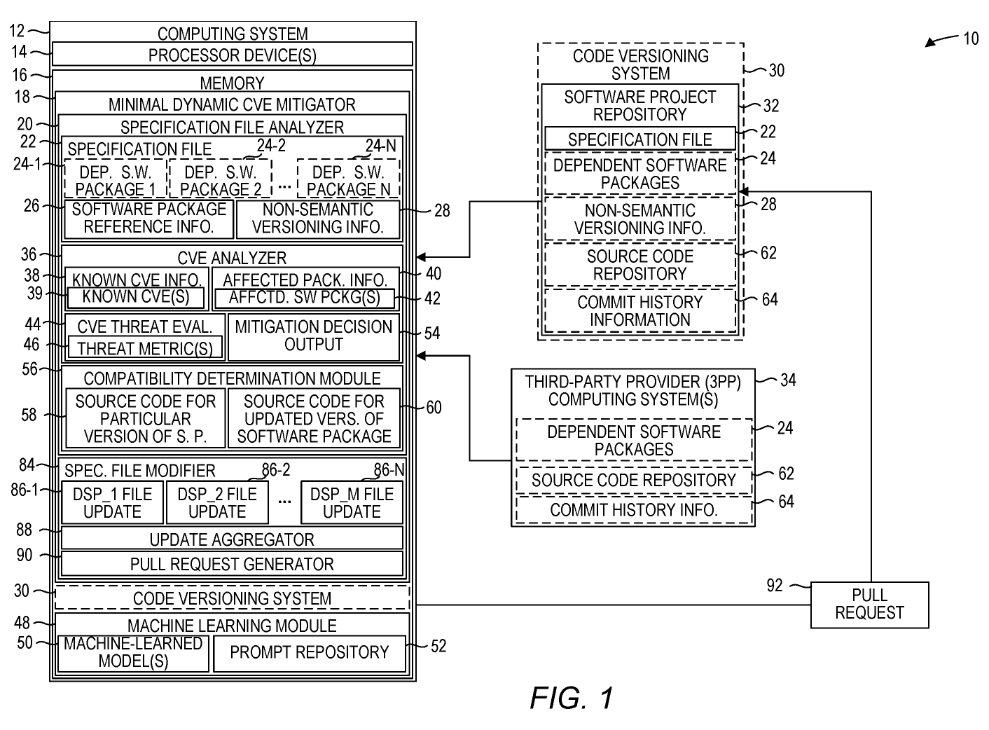

FIG. 1 is a block diagram of a computing environment 10 suitable for identifying minimal dependency updates to mitigate known CVEs for non semver software projects according to some implementations of the present disclosure. The computing environment 10 can include a computing system 12 with one or more processor device(s) 14 and a memory 16. In some implementations, the computing system 12 may be a computing system that includes multiple computing devices. Alternatively, in some implementations, the computing system 12 may be one or more computing devices within a computing system that includes multiple computing devices. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In some implementations, the computing environment 10 can include multiple types of nodes. As described herein, a “node” generally refers to a discrete unit of hardware and/or software resources. In some instances, nodes within the computing environment 10 can be configured to perform specific tasks. For example, some nodes within the computing environment 10 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

In some implementations, the computing environment 10 can be, or otherwise include, a software development environment. The computing environment 10 can include computing device(s), system(s), etc. that are utilized for developing software. For example, the computing system 12 can be a system for creating (i.e., developing) and/or maintaining a large software project (e.g., an application. To do so, the computing system 12 may maintain a codebase for the large software project, a code versioning system and/or versioning information for the codebase, etc.

In particular, the memory 16 of the computing system 12 can include a minimal dynamic CVE mitigator 18. The minimal dynamic CVE mitigator 18 can dynamically minimally mitigate known CVEs for software packages associated depended on by the large software project. As described herein, “minimal” mitigation of a known CVE performs the minimal mitigation operations necessary to mitigate a known CVE. Which mitigation operations are considered the minimal operations necessary to mitigate the known can vary based on the metric utilized to evaluate the mitigation operations (e.g., a computational cost for each operation, a likelihood that the mitigation operation will break existing dependencies, etc.). For example, assume that a known CVE is associated with two software packages depended upon by the large software project. Further assume that the developers for both software packages have recently released patches to mitigate the known CVE, and either patch is sufficient to fully mitigate the known CVE. In this instance, the computing system can perform the mitigation operation(s) necessary to mitigate the CVE, which is likely applying the patch that is least likely to break existing cross-dependencies while refraining from applying the other patch.

The minimal dynamic CVE mitigator 18 can include a specification file analyzer 20. The specification file analyzer 20 can analyze a specification file 22. The specification file 22 can be a specification or “build” file for a large software project that contains instructions for building the software project, including which dependencies need to be included, how the source code should be compiled, and what configurations should be applied during the build process. Common examples of specification files include Makefile in C/C++ projects, pom.xml in Java projects using Apache Maven®, package.json in Node.js® projects, and build.gradle in projects using Gradle®. A “dependency” included in a specification file can refer to a package of software upon which the software project depends (e.g., an Application Programming Interface (API), a software package from a package manager such as Node, a software module, a software library, a software framework such as Django or React, a software plugin, etc.).

As such, the specification file 22 can describe a plurality of dependent software packages 24-1 – 24-N (generally, dependent software packages 24). In some implementations, the specification file 22 can include some (or all) of the dependent software packages 24. As described previously, the dependent software packages 24 can refer to any type or manner of information including or otherwise derived from software instructions, such as an executable, application, Application Programming Interface (API), library, module, service, framework, plugin, function, etc.

Alternatively, in some implementations, the specification file 22 can include software package reference information 26. The software package reference information 26 can describe a location from which the dependent software packages 24 can be retrieved, a process to retrieve the dependent software packages 24, etc. For example, the software package reference information 26 may include an address for an API and instructions how to interface with the API to retrieve the software package in question.

In some implementations, the specification file 22 can include non-semantic versioning information 28. As described previously, some (or all) of the dependent software packages 24 can be versioned using non-semantic versioning techniques. Unlike semantic versioning information, the non-semantic versioning information 28 produced using these non-semantic versioning techniques generally does not indicate whether a new version of a software package mitigates a particular CVE. For example, assume that a patch is released for the dependent software package 24-1 and the non-semantic versioning information 28 is released alongside it. Even if the patch does effectively mitigate the particular CVE, the non-semantic versioning information 28 may indicate this in a non-standard or non-specific manner (e.g., “fixed major exploit,” “vulnerability patched,” etc.). Alternatively, the non-semantic versioning information 28 may simply indicate a new version number without any additional detail. As such, it can generally be assumed that the non-semantic versioning information 28 released alongside patches for the dependent software packages 24 lack specific indications as to whether patches effectively mitigate known CVEs.

In some implementations, the minimal dynamic CVE mitigator 18 can obtain the specification file 22, the dependent software packages 24, the software package reference information 26, and/or the non-semantic versioning information 28 from a code versioning system 30. In some implementations, the code versioning system can be included in and/or implemented by the minimal dynamic CVE mitigator 18. Alternatively, in some implementations, the code versioning system 30 can be located separately from the computing system 12 within the computing environment 10. Alternatively, in some implementations, the minimal dynamic CVE mitigator 18 can access the specification file from a code versioning system 30.

In some implementations, the code versioning system 30 can include a software project repository 32. The software project repository 32 can be a repository for information related to development of the large software project described previously. In some implementations, the software project repository 32 can include the specification file 22, and can provide the specification file 22 to the computing system 12 responsive to a request or some other indication (e.g., a particular amount of time passing, a CVE being discovered, a patch being released for one of the dependent software packages 24, etc.). Similarly, in some implementations, the software project repository 32 can include the non-semantic versioning information 28, and can provide the non-semantic versioning information 28 to the computing system 12 as described with regards to the specification file 22.

In some implementations, the code versioning system 30 can include the dependent software packages 24. For example, the code versioning system 30 may retrieve the dependent software packages 24 via API or a package manager when the specification file 22 is utilized to build or instantiate the large software project. Additionally, or alternatively, in some implementations, the code versioning system 30 can include the software package reference information 26, and utilize the information to retrieve the dependent software packages 24 as needed.

Additionally, or alternatively, in some implementations, the computing system 12 can obtain the specification file 22, the dependent software packages 24, the software package reference information 26, and/or the non-semantic versioning information 28 from third-party provider (TPP) computing system(s) 34. The TPP computing system(s) 34 can be any type or manner of device or system associated with some entity other than the entity associated with the computing environment 10. For example, the TPP computing system(s) 34 can be associated with third-party organizations that develop some (or all) of the dependent software packages 24. For example, one of the TPP computing system(s) 34 may refer to computing system associated with a small team of developers that develop the dependent software package 24-1 as an open-source package for Node package manager. For another example, the TPP computing system(s) 34 may refer to a software repository service, or code versioning system (e.g., the code versioning system 30), where the development team stores and maintains the codebase for the open-source package. As such, in some implementations, the TPP computing system(s) can include some of the dependent software packages 24, and can provide the dependent software packages 24 to the computing system 12.

Returning to the computing system 12, the minimal dynamic CVE mitigator 18 can include a CVE analyzer 36. The CVE analyzer 36 can analyze CVE databases, trackers, repositories, etc. to identify known CVEs associated with one (or more) of the dependent software packages 24. To do so, the CVE analyzer 36 can include known CVE information 38. The known CVE information 38 can describe known CVE(s) 39 associated with one or more of the dependent software packages 24. For example, the known CVE information 38 may be, or include, a database or repository of known CVEs. For another example, the known CVE information 38 may be a portion of information retrieved (e.g., in response to a query, etc.) from a third-party CVE repository, such as one of the TPP computing system(s) 34.

In some implementations, the CVE analyzer 36 can obtain the known CVE information 38 iteratively or on a routine basis. For example, the CVE analyzer 36 may identify each of the dependent software packages 24 currently included in the specification file 22 (e.g., by extracting identifying information from the specification file 22, from the software package reference information 26, etc.). The CVE analyzer 36 can then request the known CVE information 38 for each of the dependent software packages 24 from entities associated with the dependent software packages (e.g., a development team, developing organization, etc.), such as the TPP computing system(s) 34, etc. The CVE analyzer 36 can perform this task routinely so that known CVEs are quickly known to the CVE analyzer 36 soon after they are discovered.

As a particular example, assume that a CVE repository service, such as the CVE repository provided by the MITRE® corporation, discovers and publishes a CVE for the dependent software package 24-2. Soon after publication, the CVE analyzer 36 can autonomously query the CVE repository for known CVEs related to the dependent software package 24-2. In response, the CVE analyzer 36 can retrieve the known CVE information 38 from the CVE repository (e.g. one of the TPP computing system(s) 34, etc.).

The CVE analyzer 36 can generate affected package information 40. The affected package information 40 can be generated based on the known CVE information 38. The affected package information 40 can identify one or more affected software package(s) 42 associated with the known CVE(s) 39. In other words, the known CVE information 38, in conjunction with the affected package information 40, can associate each of the affected software package(s) 42 with one or more of the known CVE(s) 39.

In some implementations, each of the known CVE(s) 39 can be associated with a specific corresponding affected software package of the affected software package(s) 42). Additionally, or alternatively, in some implementations, one of the known CVE(s) 39 can be associated with more than one of the dependent software packages. Whether CVEs are associated to multiple software packages can depend upon the CVE repository service from which the known CVE information 38 is obtained.

In some implementations, the CVE analyzer 36 can include a CVE threat evaluator 44. The CVE threat evaluator 44 can generate threat metric(s) 46 for each of the known CVE(s) 39 associated with the dependent software packages 24. The threat metric(s) 46 can indicate a degree of threat posed by the known CVE(s) 39. In other words, the threat metric(s) 46 can indicate a level of “seriousness” or urgency with which to mitigate the known CVE(s) 39. For example, a CVE that enables remote code execution would likely receive a threat metric indicating that the CVE is of critical importance to mitigate. Conversely, a CVE that enables remote access to non-sensitive, public-facing information would likely receive a threat metric indicating that the CVE is of lower importance than the CVE described above (e.g., a threat metric of “low” or “medium,” etc.).

In some implementations, the CVE threat evaluator 44 can obtain the threat metric(s) 46 based on the known CVE information 38. For example, assume that the known CVE information 38 is obtained in response to a query to a CVE information repository. If the CVE information evaluates the severity of CVEs during the CVE discovery process, the known CVE information 38 can include such threat information.

Additionally, or alternatively, in some implementations, if the known CVE information 38 does not indicate a severity of the CVE, the CVE threat evaluator 44 can generate the threat metric(s) 46 in some other manner. Specifically, in some implementations, the memory 16 of the computing system 12 can include a machine learning module 48. The machine learning module 48 can include machine-learned model(s) 50. The machine-learned model(s) 50 can be any type or manner of machine-learned model, such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the machine-learned model(s) 50 can include a Large Foundational Model (LFM) such as a Large Language Model (LLM). As described herein, LFMs refer to models with large quantities of parameters that are trained on substantially larger corpuses of training data that conventional models. LFMs generally exhibit superior performance to smaller models of the same type. In addition, many LFMs can perform multiple types of tasks. For example, a Large Language Model (LLM) can perform a wide variety of generative language tasks (e.g., summarizing existing textual content, generating new textual content, searching for a particular word, etc.). Additionally, or alternatively, in some implementations, the machine-learned model(s) 50 can include smaller task-specific models.

In some implementations, the machine learning module 48 can train, update, or otherwise optimize the machine-learned model(s) 50. In some implementations, the machine learning module 48 can do so based on training examples. As described herein, a “training example” generally refers to input(s) that are processed with the purpose of optimizing a machine-learned model. Training examples may (or may not) include ground-truth information (e.g., labels, outputs, etc.) indicating a “correct” output that the model can be trained to reproduce when given the corresponding input of the training example. For example, the training example can include a known CVE with a “ground-truth” threat metric. The machine learning module 48 can train the machine-learned model(s) 50 by processing information describing the known CVE to generate a threat metric, and then training the machine-learned model(s) 50 with a loss function that evaluates a difference between the generated threat metric and the ground-truth threat metric.

The machine learning module 48 can utilize various training or learning techniques to train the machine-learned model(s) 50, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. In some implementations, performing backwards propagation of errors can include performing truncated backpropagation through time. The machine learning module 48 can perform a number of generalization techniques (e.g., weight decays, dropouts, etc.) to improve the generalization capability of the models being trained.

In some implementations, the CVE threat evaluator 44 can leverage the machine-learned model(s) 50 to generate the threat metric(s) 46. For example, the machine learning module 48 can include a prompt repository 52. The prompt repository 52 can include various prompts that can cause the machine-learned model(s) 50 to perform specific tasks when ingested. The prompt repository 52 can include a prompt that instructs the machine-learned model(s) 50 to process information describing a known CVE and assign a threat metric to the CVE based on the information. Additionally, or alternatively, in some implementations, the machine-learned model(s) 50 can include a machine-learned model specifically trained to generate threat metrics given descriptions of CVEs.

In some implementations, the CVE analyzer 36 can generate a mitigation decision output 54. The mitigation decision output 54 can be based on the known CVE information 38, the affected package information 40, and/or the non-semantic versioning information 28. The mitigation decision output 54 can describe a mitigation decision for each of the known CVE(s) 39. A mitigation decision refers to a decision whether to perform mitigation operation(s) necessary to mitigate a known CVE.

For example, assume that one of the threat metric(s) 46 for one of the known CVE(s) 39 indicates a low threat level associated with the known CVE. Based on the low threat level, the mitigation decision output 54 may indicate to refrain from mitigating the known CVE, as the potential cost of mitigating the CVE (e.g., possibly introducing bugs or breaking dependencies) may outweigh the benefit provided by mitigating the CVE. For another example, further assume that two mitigation operations can be performed to mitigate the CVE described in the previous example: patching the affected software package or replacing the affected software package with a different package that provides the same functionality. In this instance, if the CVE determines that the affected software package can be switched with minimal disruptions, the mitigation decision output 54 can indicate that the affected software package be replaced rather than patched.

In some implementations, the specification file analyzer can include a compatibility determination module 56. The compatibility determination module 56 can identify an updated version of one (or more) of the affected software packages 42. The compatibility determination module 56 can then determine whether the updated version of the affected software package 42 is compatible with the other dependent software packages 24 of the specification file 22.

In some implementations, the compatibility determination module 56 can determine a compatibility between updated version(s) of the affected software package(s) 42 and other packages of the affected software packages 42 based on a particular source code version 58 for the software package currently being used, and an updated source code version 60 for the software package once updated. The particular source code version 58 can be the source code for the version of the software package currently depended on by the large software project. The updated source code version 60 can be the source code for the version of the software package following an update designed to mitigate the known CVE(s) 39 associated with the affected software package(s) 42.

For example, assume that one of the TPP computing system(s) 34 includes a source code repository 62 for one of the affected software package(s) 42. The compatibility determination module 56 can obtain the particular source code version 58 for the software package currently being used, and an updated source code version 60 for the software package from the source code repository 62.

Additionally, or alternatively, in some implementations, the compatibility determination module 56 can determine a compatibility between updated version(s) of the affected software package(s) 42 and other packages of the affected software packages 42 based on commit history information 64. The commit history information 64 can be metadata, comments, textual content, change information (e.g., information indicating changes between source code versions), etc. stored within a software project repository (e.g., the code versioning system 30, the software project repository 32, a different code versioning system or software project repository associated with the software package, etc.).For example, assume that one of the TPP computing system(s) 34 is a code versioning system that maintains a codebase of one of the affected software package(s) 42. The compatibility determination module 56 can query the code versioning system to obtain the commit history information 64, and the commit history information 64 can indicate any changes made between the particular version and the updated version of the software package.

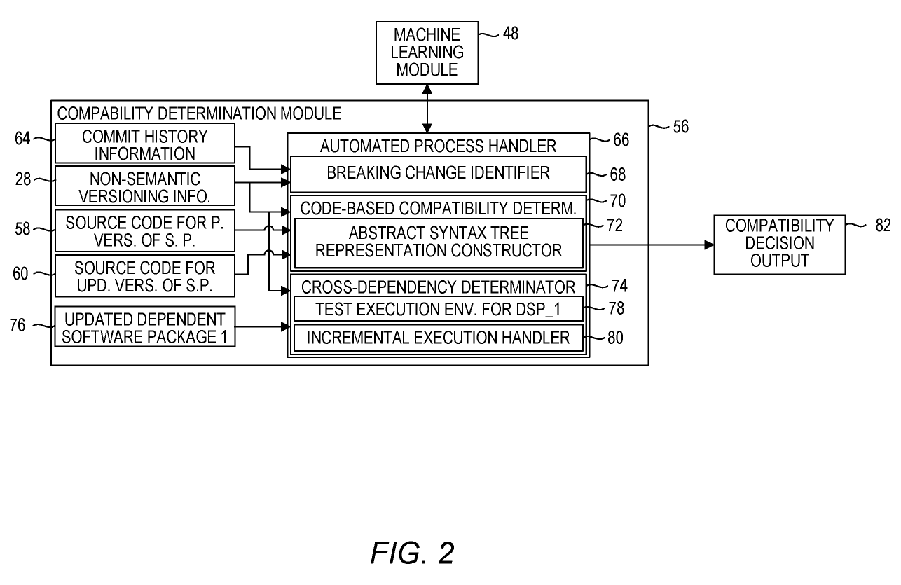

For a more specific example, turning to FIG. 2, FIG. 2 is a data flow diagram for the compatibility determination module 56 of FIG. 1 being utilized to determine compatibility of updated dependent software packages according to some implementations of the present disclosure. More specifically, the compatibility determination module 56 can obtain the commit history information 64, the non-semantic versioning information 28, the particular source code version 58, and/or the updated source code version 60 as described with regards to FIG. 1.

The compatibility determination module 56 can include an automated process handler 66. The automated process handler 66 can perform a number of automated processes to determine whether an updated version of one of the dependent software packages 24 is compatible with other software packages, or otherwise breaks existing dependencies. Specifically, in some implementations, the automated process handler 66 can include a breaking change identifier 68 that can perform a breaking change identification process. To do so, the breaking change identifier 68 can process the commit history information 64. The commit history information 64 can describe one or more changes made to the dependent software package between the particular source code version 58 and the updated source code version 60. Based on the commit history information 64, the computing system can determine that each of the one or more changes comprise non-breaking changes.

As described herein, a “non-breaking change” refers to a change that does not break an existing dependency between the dependent software package and the software project. In this context, a “dependency” refers to some functionality (e.g., function, API, module, etc.) of the software package that is invoked by another software package or software instructions of the large software project. For example, assume that one of the changes indicated by the commit history information modifies an invokable function of the dependent software package to replace an algorithm with a more secure algorithm that provides the same expected outputs. Here, since the manner in which the invokable function is accessed has not changed, and the expected output of the function is the same, the change is likely to be considered a non-breaking change. Conversely, if the changes changed the name by which the invokable function is invoked, the change may be considered a breaking change.

In some instances, the breaking change identifier 68 may be unable to determine whether a change is breaking (e.g., above a threshold degree of certainty, etc.). In such instances, the breaking change identifier 68 can access the machine learning module 48 to process the commit history information 64 with one of the machine-learned models 50. For example, the breaking change identifier 68 can process the commit history information 64 with an LLM of the machine-learned model(s) 50 alongside a prompt instructing the LLM to determine whether the changes are likely to break existing dependencies.

In some implementations, the automated process handler 66 can include a code-based compatibility determinator 70. The code-based compatibility determinator 70 can be utilized in lieu of, or in addition to, the breaking change identifier 68 (e.g., when commit history information 64 is unavailable, etc.). The code-based compatibility determinator 70 can perform a source code compatibility determination process by analyzing the particular source code version 58 and the updated source code version 60 to determine whether any dependencies or compatibilities that exist with the particular source code version 58 remain unbroken by the updated source code version 60.

Specifically, in some implementations, the code-based compatibility determinator 70 can include an abstract syntax tree representation constructor 72. The abstract syntax tree representation constructor 72 can construct intermediate representations of the particular source code version 58 and the updated source code version 60, such as abstract syntax tree representations. The abstract syntax tree representations of each source code version can describe invokable functions included in each source code version and any specific invocations of those invokable functions found in the source code. Specifically, the abstract syntax tree invocations can indicate data flows, behavior, invoked functions, etc. in a name-agnostic manner so that “superficial” changes that do not affect behavior can be filtered. By comparing the abstract syntax tree representations, the code-based compatibility determinator 70 can determine whether the updated source code version 60 is compatible. Additionally, or alternatively, in some implementations, the code-based compatibility determinator 70 can leverage the machine-learned model(s) 50 as described with regards to the breaking change identifier 68.

In some implementations, the automated process handler 66 can include a cross-dependency determinator 74. The cross-dependency determinator 74 can be utilized in lieu of, or in addition to, the breaking change identifier 68 and/or the code-based compatibility determinator 70 (e.g., when commit history information 64 is unavailable, when the particular source code version 58 and/or the updated source code version 60 are unavailable, etc.). The cross-dependency determinator 74 can perform a cross-dependency compatibility determination process by instantiating a test execution environment for the software project using the updated version of the dependent software package.

In some implementations, to do so, the cross-dependency determinator 74 can obtain an updated dependent software package 76. The updated dependent software package 76 can be an updated version of one of the dependent software packages 24 (e.g., the dependent software package 24-1, etc.). For example, the compatibility determination module 56 may obtain an updated dependent software package 76 by applying the update released for the software package (e.g., the update associated with the updated source code version 60). For another example, the compatibility determination module 56 may obtain the updated dependent software package 76 by receiving the updated dependent software package 76 from an entity that maintains the updated dependent software package 76 (e.g., one of the TPP computing system(s) 34, etc.).

Alternatively, in some implementations, the cross-dependency determinator 74 can obtain information for accessing the updated dependent software package 76, such as the software package reference information 26. Rather than manipulating the updated dependent software package 76 directly, the cross-dependency determinator 74 can modify the specification file 22 such that the large software project is built using the updated dependent software package 76 rather than the dependent software package 24-1 that is associated with the known CVE(s) 39.

For example, assume that the updated dependent software package 76 is an updated version of the dependent software package 24-1. The cross-dependency determinator 74 can instantiate a test execution environment 78 for the dependent software package 24-1. The cross-dependency determinator 74 can then instantiate a baseline test instance of the large software project within the test execution environment 78. The baseline test instance is built using the specification file 22, and as such, the baseline test instance can utilize the particular version of the dependent software package 24-1 that is associated with a known CVE. The cross-dependency determinator 74 can evaluate existing dependencies within the baseline instance of the test execution environment 78 to establish “baseline” information describing current or existing dependencies.

Alternatively, if such baseline information already exists, the cross-dependency determinator 74 can instantiate an update test instance of the large software project within the test execution environment 78. Unlike the baseline test instance which utilizes the dependent software package 24-1, the update test instance can utilize the updated dependent software package 76. For example, the compatibility determination module 56 may modify the specification file 22 such that the update test instance of the large software project is built using the updated dependent software package 76. The cross-dependency determinator 74 can then re-evaluate the existing dependencies within the update instance of the test execution environment 78 to determine whether any existing dependencies have been broken by the updated dependent software package 76.

In some implementations, the cross-dependency determinator 74 can include an incremental execution handler 80. The incremental execution handler 80 can incrementally modify and/or re-instantiate the text execution environment 78 to iteratively test updated dependent software packages for other packages of the affected software package(s) 42. For example, assume that the dependent software package 24-2 is one of the affected software package(s) 42, and an updated version of the dependent software package 24-2 has been released. If the updated dependent software package 76 does not break existing dependencies in the test execution environment 78, the cross-dependency determinator can modify the test execution environment 78 (or the specification file 22) to utilize the updated version of the dependent software package 24-2 in addition to the updated dependent software package 76. In this manner, the compatibility determination module 56 can further evaluate dependencies between multiple updated versions of the dependent software packages 24 to more accurately verify compatibility.

In some implementations, the compatibility determination module 56 can generate a compatibility decision output 82. In some implementations, the compatibility decision output 82 can indicate a binary decision whether the updated dependent software package 76 is compatible with the large software project. Alternatively, in some implementations, the compatibility decision output 82 can indicate a degree of compatibility associated with the updated dependent software package 76.

Returning to FIG. 1, in some implementations, the mitigation decision output 54 can be based at least in part on the compatibility decision output 82. For example, assume that the dependent software package 24-N is one of the affected software package(s) 42. If the threat metric(s) 46 generated for the known CVE(s) 39 associated with the dependent software package 24-N is low, the mitigation decision output 54 may be to refrain from updating the dependent software package 24-N. However, if the compatibility decision output 82 for the dependent software package 24-N is substantially high (e.g., few or no breaks in existing dependencies), the mitigation decision output for the dependent software package 24-N may be to proceed with updating the dependent software package 24-N.

The minimal dynamic CVE mitigator 18 can include a specification file modifier 84. The specification file modifier 84 can generate one or more file update(s) 86-1 – 86-N (generally, file update(s) 86). The file update(s) 86 can be generated for at least one of the affected software package(s) 42. In some implementations, the specification file modifier 84 can determine whether to generate each of the file update(s) 86 based on the mitigation decision output 54. For example, if the mitigation decision output 54 is positive for the dependent software package 24-1, the specification file modifier 84 can generate a specification file update 86-1 to update the specification file to utilize the updated version of the dependent software package 24-1. Conversely, if the mitigation decision output 54 is negative for the dependent software package 24-2, the specification file modifier 84 can determine to refrain from generating a specification file update 86-2 to update the specification file to utilize the updated version of the dependent software package 24-2.

In some implementations, the specification file modifier 84 can include an update aggregator 88. The update aggregator 88 can aggregate the specification file updates 86 to generate an aggregated specification file update 86. In this manner, the update aggregator 88 can be leveraged to more efficiently update existing specification build files located at remote systems or devices.

In some implementations, the specification file modifier 84 can include a pull request generator 90. The pull request generator 90 can generate a pull request 92 for the code versioning system 30. The pull request 92 can be a request that the code versioning system 30 incorporate the specification file updates 86. In this manner, the minimal dynamic CVE mitigator 18 can dynamically generate pull requests for a code versioning system, so that the requests can be automatically or manually accepted.

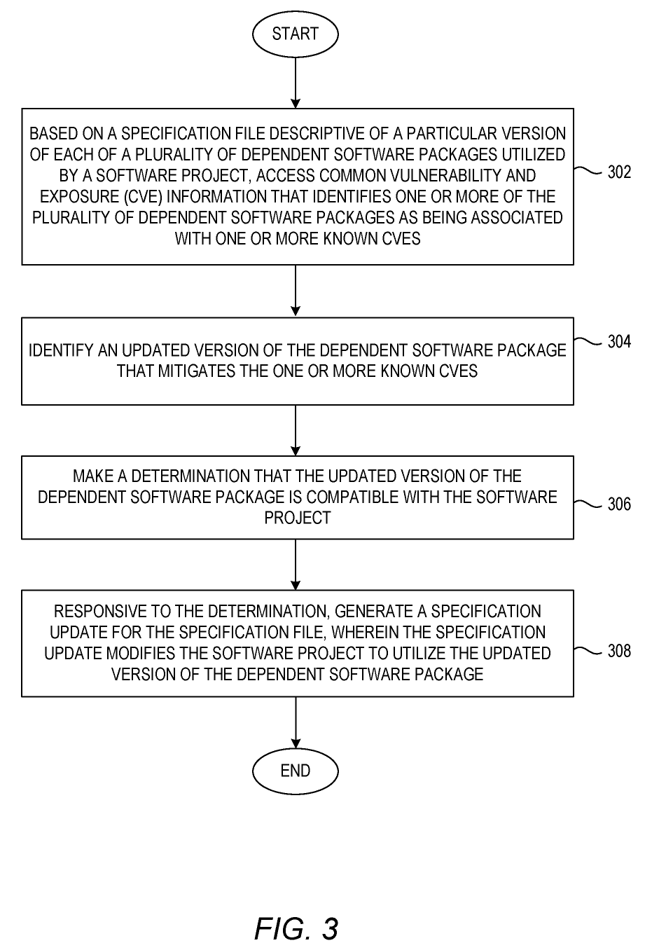

FIG. 3 is a flowchart illustrating operations performed by the computing system of FIG. 1 for identifying minimal dependency updates to mitigate known CVEs for software projects without semantic versioning, according to one example. Elements of FIG. 1 are referenced in describing FIG. 3 for the sake of clarity. In FIG. 3, operations begin with a processor device of a computing device, computing system, network node, etc., such as the processor device(s) 14 of the computing system 12 of FIG. 1. The processor device(s) 14 are to access, based on a specification file 22 descriptive of a particular version of each of a plurality of dependent software packages 24, CVE information 38 that identifies a first dependent software package 24-1 of the plurality of dependent software packages 24 as being associated with a known CVE 39 (block 302). The processor device(s) 14 are further to identify an updated version of the first dependent software package 24-1 (e.g., updated dependent software package 76) that mitigates the known CVE 39 (block 304). The processor device(s) 14 are further to make a determination that the updated version of the first dependent software package 24-1 (e.g., the updated dependent software package 76) is compatible with the software project (block 306). The processor device(s) 14 are further to, responsive to the determination, generate a specification update 86-1 for the specification file 22, wherein the specification update 86-1 modifies the specification file 22 such that the software project utilizes the updated version of the first dependent software package 24-1 (e.g., the updated dependent software package 76) (block 308).

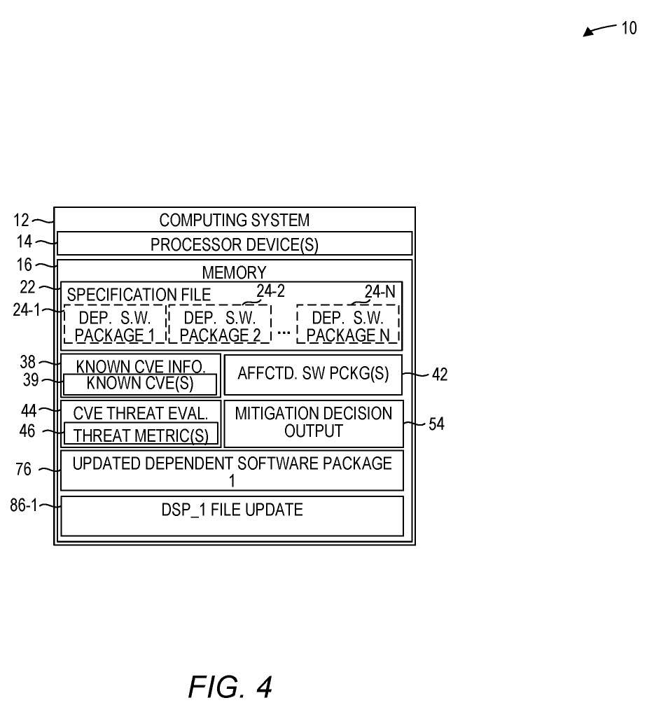

FIG. 4 is a block diagram of the computing device of FIG. 1 for identifying minimal dependency updates to mitigate known CVEs for software projects without semantic versioning, according to one example. Elements of FIG. 1 are referenced in describing FIG. 4 for the sake of clarity. In the example of FIG. 4, the computing system 12 includes a memory 16 and processor device(s) 14 coupled to the memory 16. The processor device(s) 14 are to, based on a specification file 22 descriptive of a particular version of each of a plurality of dependent software packages 24 utilized by a software project, access CVE information 38 that identifies a first dependent software package 24-1 of the plurality of dependent software packages 24 as being associated with a known CVE 39. The processor device(s) 14 are further to identify an updated version 76 of the first dependent software package 24-1 that mitigates the known CVE 39. The processor device(s) 14 are further to make a determination that the updated version 76 of the first dependent software package 24-1 is compatible with the software project. The processor device(s) 14 are further to, responsive to the determination, generate a specification update 86-1 for the specification file 22, wherein the specification update 86-1 modifies the specification file 22 such that the software project utilizes the updated version 76 of the first dependent software package 24-1.

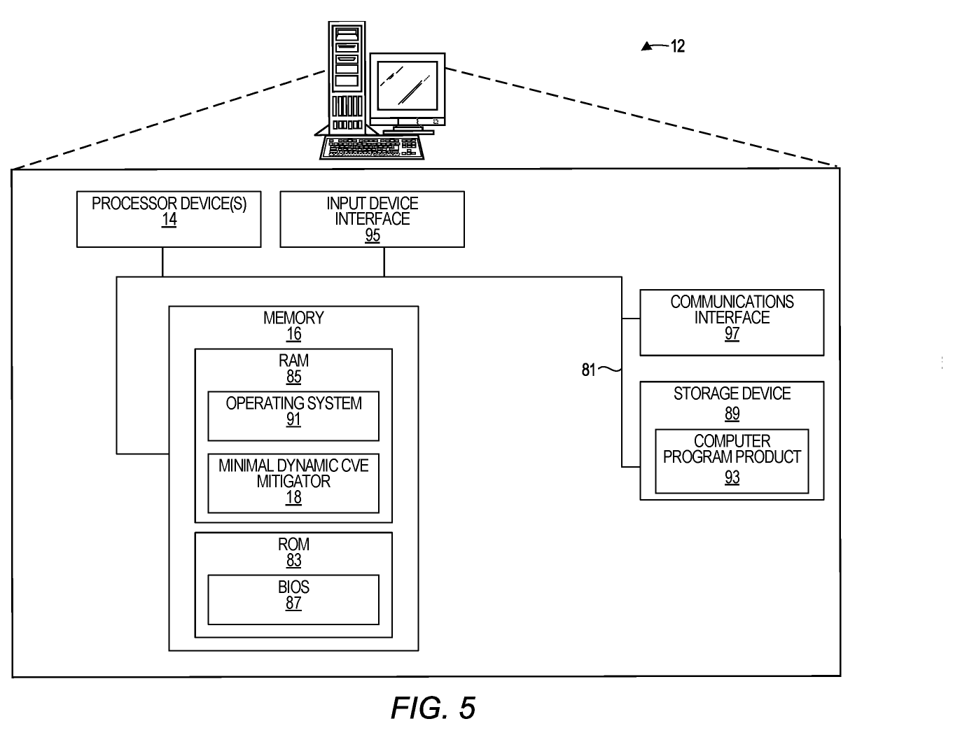

FIG. 5 is a block diagram of the computing system 12 suitable for implementing examples according to one example. The computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 12 includes the processor device(s) 14, the memory 16, and a system bus 81. The system bus 81 provides an interface for system components including, but not limited to, the memory 16 and the processor device(s) 14. The processor device(s) 14 can be any commercially available or proprietary processor.

The system bus 81 may be any of several types of bus structures that may further interconnect to a memory bus (with or without a memory controller), a peripheral bus, and/or a local bus using any of a variety of commercially available bus architectures. The memory 16 may include non-volatile memory 83 (e.g., read-only memory (ROM), erasable programmable read-only memory (EPROM), electrically erasable programmable read-only memory (EEPROM), etc.), and volatile memory 85 (e.g., random-access memory (RAM)). A basic input/output system (BIOS) 87 may be stored in the non-volatile memory 83 and can include the basic routines that help to transfer information between elements within the computing system 12. The volatile memory 85 may also include a high-speed RAM, such as static RAM, for caching data.

The computing system 12 may further include or be coupled to a non-transitory computer-readable storage medium such as the storage device 89, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 89 and other drives associated with computer-readable media and computer-usable media may provide non-volatile storage of data, data structures, computer-executable instructions, and the like.

A number of modules can be stored in the storage device 89 and in the volatile memory 85, including an operating system 91 and one or more program modules, such as the minimal dynamic CVE mitigator 18, which may implement the functionality described herein in whole or in part. All or a portion of the examples may be implemented as a computer program product 93 stored on a transitory or non-transitory computer-usable or computer-readable storage medium, such as the storage device 89, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the minimal dynamic CVE mitigator 18 in the volatile memory 85, may serve as a controller, or control system, for the computing system 12 that is to implement the functionality described herein.

Because the minimal dynamic CVE mitigator 18 is a component of the computing system 12, functionality implemented by the minimal dynamic CVE mitigator 18 may be attributed to the computing system 12 generally. Moreover, in examples where the minimal dynamic CVE mitigator 18 comprises software instructions that program the processor device(s) 14 to carry out functionality discussed herein, functionality implemented by the minimal dynamic CVE mitigator 18 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 95 that is coupled to the system bus 81 but can be connected by other interfaces such as a parallel port, an Institute of Electrical and Electronic Engineers (IEEE) 1394 serial port, a Universal Serial Bus (USB) port, an IR interface, and the like. The computing system 12 may also include the communications interface 97 suitable for communicating with the network as appropriate or desired. The computing system 12 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method comprising:
based on a specification file descriptive of a particular version of each of a plurality of dependent software packages utilized by a software project, accessing, by a computing system comprising one or more computing devices, Common Vulnerability and Exposure (CVE) information that identifies a first dependent software package of the plurality of dependent software packages as being associated with a known CVE;
identifying, by the computing system, an updated version of the first dependent software package that mitigates the known CVE;
making, by the computing system, a determination that the updated version of the first dependent software package is compatible with the software project; and
responsive to the determination, generating, by the computing system, a specification update for the specification file, wherein the specification update modifies the specification file such that the software project utilizes the updated version of the first dependent software package.

2. The method of claim 1, wherein, prior to accessing the specification file, the method comprises:
obtaining, by the computing system, the specification file from an entity associated with the software project.

3. The method of claim 2, wherein obtaining the specification file from the entity associated with the software project comprises:
accessing, by the computing system, the specification file from a code versioning system for the software project.

4. The method of claim 3, wherein generating the specification update for the specification file comprises:
generating, by the computing system, a pull request descriptive of the specification update for the specification file, the specification update modifying the software project to utilize the updated version of the first dependent software package; and
sending, by the computing system, the pull request to the code versioning system.

5. The method of claim 3, wherein the first dependent software package associated with the known CVE is one of a subset of dependent software packages of the plurality of dependent software packages, wherein the subset of dependent software packages is associated with a plurality of known CVEs comprising the known CVE, and wherein generating the specification update for the specification file comprises:
generating, by the computing system, a plurality of specification updates for the specification file, wherein each of the plurality of specification updates modifies the specification file such that the software project utilizes an updated version of a corresponding dependent software package of the subset of dependent software packages.

6. The method of claim 5, wherein the method further comprises:
aggregating, by the computing system, the plurality of specification updates generated for the subset of dependent software packages associated with the plurality of known CVEs to obtain an aggregated specification update; and
applying, by the computing system, the aggregated specification update to the specification file.

7. The method of claim 1, wherein the first dependent software package comprises:
an Application Programming Interface (API);
a module;
a software library;
a software framework;
a plugin; or
a third-party application.

8. The method of claim 1, wherein making the determination that the updated version of the first dependent software package is compatible with the software project comprises performing, by the computing system, one or more automated compatibility determination processes comprising at least one of:
a breaking change identification process;
a source code compatibility determination process; or
a cross-dependency compatibility determination process.

9. The method of claim 8, wherein performing the one or more automated compatibility determination processes comprises performing, by the computing system, the breaking change identification process, and wherein performing the breaking change identification process comprises:
obtaining, by the computing system, commit history information descriptive of one or more changes made to the first dependent software package between the particular version of the first dependent software package and the updated version of the first dependent software package; and
based on the commit history information, determining, by the computing system, that each of the one or more changes comprises non-breaking changes that retain an existing dependency between the first dependent software package and the software project.

10. The method of claim 9, wherein determining that each of the one or more changes comprises the non-breaking changes that retain the existing dependency between the first dependent software package and the software project comprises:
processing, by the computing system, the commit history information with a machine-learned language model to obtain an output indicating that each of the one or more changes comprises the non-breaking changes that retain the existing dependency between the first dependent software package and the software project.

11. The method of claim 8, wherein performing the one or more automated compatibility determination processes comprises performing, by the computing system, the source code compatibility determination process, and wherein performing the source code compatibility determination process comprises:
obtaining, by the computing system, a particular version of source code for the particular version of the first dependent software package;
obtaining an updated version of source code for the updated version of the first dependent software package; and
determining, by the computing system, that invocations to invoke invokable functions are retained between the particular version of the source code and the updated version of the source code.

12. The method of claim 11, wherein determining that the invocations to invoke the invokable functions are retained between the particular version of the source code and the updated version of the source code comprises:
constructing, by the computing system, an abstract syntax tree representation of the particular version of the source code;
constructing, by the computing system, an abstract syntax tree representation of the updated version of the source code; and
comparing, by the computing system, the abstract syntax tree representation of the particular version of the source code and the abstract syntax tree representation of the updated version of the source code to determine that the invocations to invoke the invokable functions are retained between the particular version of the source code and the updated version of the source code.

13. The method of claim 11, wherein determining that the invocations to invoke the invokable functions are retained between the particular version of the source code and the updated version of the source code comprises:
processing, by the computing system, the particular version of the source code and the updated version of the source code with a machine-learned language model to obtain an output indicating that the invocations to invoke the invokable functions are retained between the particular version of the source code and the updated version of the source code.

14. The method of claim 8, wherein performing the one or more automated compatibility determination processes comprises performing, by the computing system, the cross-dependency compatibility determination process, and wherein performing the cross-dependency compatibility determination process comprises:
instantiating, by the computing system, a test execution environment for the software project using the updated version of the first dependent software package; and
executing, by the computing system, a unit test suite configured to evaluate compatibility between the updated version of the first dependent software package and other dependent software packages of the plurality of dependent software packages.

15. The method of claim 1, wherein identifying the updated version of the first dependent software package comprises:
determining, by the computing system, a threat metric for the known CVE associated with the first dependent software package; and
responsive to the threat metric being greater than a threshold threat metric, identifying, by the computing system, the updated version of the first dependent software package as a version of the first dependent software package that mitigates the known CVE.

16. A computing system comprising:
one or more computing devices to:
based on a specification file descriptive of a particular version of each of a plurality of dependent software packages utilized by a software project, access Common Vulnerability and Exposure (CVE) information that identifies a first dependent software package of the plurality of dependent software packages as being associated with a known CVE;
identify an updated version of the first dependent software package that mitigates the known CVE;
make a determination that the updated version of the first dependent software package is compatible with the software project; and
responsive to the determination, generate a specification update for the specification file, wherein the specification update modifies the specification file such that the software project utilizes the updated version of the first dependent software package.

17. The computing system of claim 16, wherein, prior to accessing the specification file, the one or more computing devices are to:
obtain the specification file from an entity associated with the software project.

18. The computing system of claim 17, wherein, to obtain the specification file from the entity associated with the software project, the one or more computing devices are to:
access the specification file from a code versioning system for the software project.

19. The computing system of claim 18, wherein, to generate the specification update for the specification file, the one or more computing devices are to:
generate a pull request descriptive of the specification update for the specification file, the specification update modifying the software project to utilize the updated version of the first dependent software package; and
send the pull request to the code versioning system.

20. A non-transitory computer-readable storage medium that includes executable instructions to cause one or more processor devices to:
based on a specification file descriptive of a particular version of each of a plurality of dependent software packages utilized by a software project, access Common Vulnerability and Exposure (CVE) information that identifies a first dependent software package of the plurality of dependent software packages as being associated with a known CVE;
identify an updated version of the first dependent software package that mitigates the known CVE;
make a determination that the updated version of the first dependent software package is compatible with the software project; and
responsive to the determination, generate a specification update for the specification file, wherein the specification update modifies the specification file such that the software project utilizes the updated version of the first dependent software package.
